(19) United States
(12) Patent Application Publication
(10) Pub. No.: US 2011/0097509 A1
(43) Pub. Date: Apr. 28, 2011

(54) MAGNETIC RECORDING MEDIUM, METHOD OF MANUFACTURING THE SAME AND MAGNETIC RECORDING APPARATUS

(75) Inventor: Hiroyuki HYODO, Hino-shi (JP)

(73) Assignee: KABUSHIKI KAISHA TOSHIBA, Tokyo (JP)

(21) Appl. No.: 12/984,028

(22) Filed: Jan. 4, 2011

Related U.S. Application Data
(62) Division of application No. 12/635,578, filed on Dec. 10, 2009.

(30) Foreign Application Priority Data
Dec. 12, 2008 (JP) 2008-317381

(51) Int. Cl. B05D 5/12

(52) U.S. Cl. 427/523

(57) ABSTRACT

According to one embodiment, a magnetic recording medium includes two or more magnetic recording layers stacked on a nonmagnetic substrate, and a carbon-based protective layer formed on the two or more magnetic recording layers, in which an uppermost one of the two or more magnetic recording layers has hardness higher than that of a lower magnetic recording layer.

### CROSS-REFERENCE TO RELATED APPLICATIONS

This application is a division of U.S. patent application Ser. No. 12/635,578, filed on Dec. 10, 2009, which is based upon and claims the benefit of priority from Japanese Patent Application No. 2008-317381, filed Dec. 12, 2008, the entire contents of each of which are incorporated herein by reference.

### BACKGROUND

1. Field

One embodiment of the present invention relates to a magnetic recording medium, a method of manufacturing the magnetic recording medium and a magnetic recording apparatus comprising the magnetic recording medium.

2. Description of the Related Art

The magnetic recording medium installed in a hard disk drive (HDD) has a structure that, on a nonmagnetic substrate, an underlayer, two or more magnetic recording layers and a carbon-based protective layer are sequentially deposited and a lubricant such as perfluoropolyether is applied to the protective layer.

In accordance with the enhancement of the recording density of the magnetic recording medium, it is required to reduce the thickness of the carbon-based protective layer. Despite the reduction of the thickness, the carbon-based protective layer should maintain corrosion resistance. Since the carbon-based protective layer is demanded to reduce the thickness to 3 nm or less in future, however, it is becoming difficult to improve the corrosion resistance of the magnetic recording medium by the carbon-based protective layer only. If the corrosion resistance of the magnetic recording medium is deteriorated, the disadvantage of elution of cobalt from the magnetic recording layer would occur.

Conventionally, it has been attempted to enhance the corrosion resistance of the magnetic recording medium by, for example, reducing the average grain size of columnar crystals on the surface of the uppermost one of the two or more magnetic recording layers constituting the magnetic recording medium to thereby increase the density of the uppermost magnetic recording layer. See Jpn. Pat. Appln. KOKAI Publication No. 5-73881. However, the corrosion resistance of such a magnetic recording medium is not satisfactory, and there is still room for the improvement of the corrosion resistance.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a cross-sectional view of a magnetic recording medium according to an embodiment of the present invention; and

FIG. 2 is a perspective view of a magnetic recording apparatus comprising a magnetic recording media according to the present invention.

### DETAILED DESCRIPTION

Various embodiments according to the invention will be described hereinafter with reference to the accompanying drawings. In general, according to one embodiment of the invention, there is provided A magnetic recording medium comprising: two or more magnetic recording layers stacked on a nonmagnetic substrate; and a carbon-based protective layer formed on the two or more magnetic recording layers, wherein an uppermost one of the two or more magnetic recording layers has hardness higher than that of a lower magnetic recording layer.

The cathodic arc discharge technique (or filtered cathodic arc technique; FCA technique) for use in the present invention is a method in which a target material is fused and ionized by arc discharge and while removing neutral atoms through a magnet filter, only ions are caused to reach a substrate and deposit thereon. This method achieves energy of particles greater than that in the sputtering method, so that a highly dense, highly hard film can be obtained. A Co-based alloy is used as the target.

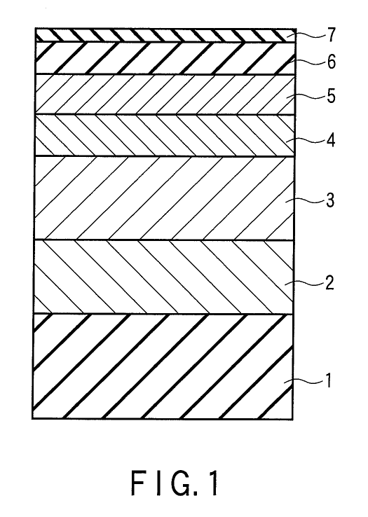

FIG. 1 is a cross-sectional view of a magnetic recording medium according to an embodiment of the present invention. The soft magnetic underlayer 2, interlayer 3, first magnetic recording layer 4, second magnetic recording layer 5 and carbon-based protective layer 6 with a thickness of 5 nm are sequentially stacked on nonmagnetic substrate 1. Lubricant 7 is applied to the carbon-based protective layer 6.

The materials appropriately used in the present invention will be described below.

<Soft Magnetic Underlayer>

The magnetic recording medium of FIG. 1 is a so-called perpendicular double-layer medium having a perpendicular magnetic recording layer stacked on a soft magnetic underlayer (SUL). The soft magnetic underlayer of the perpendicular double-layer medium is configured to allow the write field from the write pole to pass through and to return to the return yoke disposed in the vicinity of the write pole. That is, the soft magnetic underlayer bears a part of the functions of the write head and fulfills the role of applying a sharp perpendicular magnetic field to the recording layer to thereby attain an enhancement of recording efficiency.

A high-permeability material comprising at least one of Fe, Ni and Co is used as the material of the soft magnetic underlayer. Examples of the material include an FeCo alloy such as FeCo and FeCoV, an FeNi alloy such as FeNi, FeNiMo, FeNiCr and FeNiSi, an FeAl or FeSi alloy such as FeAl, FeAlSi, FeAlSiCr, FeAlSiTiRu and FeAlO, an FeTa alloy such as FeTa, FeTaC and FeTaN, and an FeZr alloy such as FeZrN.

Further, a material having a microcrystal structure of FeAlO, FeMgO, FeTaN, FeZrN or the like which comprises Fe in 60 at % or more or having a granular structure in which microcrystal grains are dispersed in a matrix can be used for the soft magnetic underlayer.

The soft magnetic underlayer may consist of another material composed of a Co alloy containing Co and at least one of Zr, Hf, Nb, Ta, Ti and Y. Co is contained preferably in 80 at % or more. When such a Co alloy is deposited by sputtering, an amorphous layer tends to be formed. The amorphous soft magnetic material exhibits excellent soft magnetism because of the absence of crystal magnetic anisotropy, crystal defects and grain boundaries. Moreover, reduction of medium noise can be attained by the employment of the amorphous soft magnetic material. Examples of the amorphous soft magnetic material include, for example, a CoZr, CoZrNb and CoZrTa alloy.

A further underlayer may be disposed under the soft magnetic underlayer in order to enhance the crystallinity of the soft magnetic underlayer or enhance the adhesion between the soft magnetic underlayer and the substrate. Examples of the material of the underlayer include Ti, Ta, W, Cr or Pt, or an alloy containing any of these, or an oxide or nitride thereof.

An interlayer (crystal orientation control layer) of nonmagnetic material may be interposed between the soft magnetic underlayer and the perpendicular magnetic recording layer. The roles of the interlayer are to block any exchange coupling interaction between the soft magnetic underlayer and the recording layer and to control the crystallinity of the recording layer. Examples of the material of the interlayer include Ru, Pt, Pd, W, Ti, Ta, Cr or Si, or an alloy containing any of these, or an oxide or nitride thereof.

For the prevention of spike noise, the soft magnetic underlayer may be divided into a plurality of layers with Ru having a thickness of 0.5 to 1.5 nm interposed therebetween so that they are anti-ferromagnetically coupled. Further, the soft magnetic underlayer may be exchange-coupled with either a hard magnetic layer with longitudinal anisotropy such as CoCrPt, SmCo and FePt or a pinning layer of an anti-ferromagnetic material such as IrMn and PtMn. In this case, a magnetic layer such as Co or a nonmagnetic layer such as Pt may be disposed under or on the Ru layer for controlling exchange coupling force.

<Perpendicular Magnetic Recording Layer>

For example, a material containing Co as a main component, further containing at least Pt optionally together with Cr and still further containing an oxide (for example, silicon oxide or titanium oxide) is used for the perpendicular magnetic recording layer. In the perpendicular magnetic recording layer, it is preferred for magnetic crystal grains to form a columnar structure. The perpendicular magnetic recording layer having this structure is excellent in the orientation and crystallinity of magnetic crystal grains with the result that a signal-to-noise ratio (S/N ratio) suitable for high-density recording can be provided. In order to obtain the above structure, the amount of oxide is important. The oxide content is preferably in the range of 3 to 12 mol %, more preferably 5 to 10 mol %, of the total amount of Co, Pt and Cr. When the oxide content of the perpendicular magnetic recording layer falls within the above range, the oxide would precipitate around magnetic grains so that the magnetic grains can be isolated and micronized. When the oxide content exceeds the above range, the oxide would remain in magnetic grains to thereby deteriorate the orientation and crystallinity of magnetic grains. Moreover, the oxide would precipitate under or on the magnetic grains with the result that any columnar structure having magnetic grains perpendicularly passing through the perpendicular magnetic recording layer would not be formed. On the other hand, when the oxide content is less than the above range, the isolation and micronization of magnetic grains would be unsatisfactory with the result that the noise in reading recorded data would increase, making it impossible to provide a signal-to-noise ratio (S/N ratio) suitable for high-density recording.

It is preferred for the Pt content of the perpendicular magnetic recording layer to fall within the range of 10 to 25 at %. When the Pt content falls within the above range, a uniaxial magnetic anisotropy constant Ku required for the perpendicular magnetic recording layer can be provided, and the crystallinity and orientation of magnetic grains are improved. As a result, thermal fluctuation and read/write characteristics suitable for high-density recording can be attained. When the Pt content exceeds the above range, a layer with fcc structure would be formed in magnetic grains, which may deteriorate the crystallinity and orientation. On the other hand, when the Pt content is less than the above range, Ku and thermal fluctuation characteristics suitable for high-density recording cannot be attained.

The Cr content of the perpendicular magnetic recording layer is preferably in the range of 0 to 16 at %, more preferably 10 to 14 at %. When the Cr content falls within the above range, a high magnetization can be maintained without reducing the uniaxial magnetic anisotropy constant Ku of magnetic grains with the result that the read/write characteristics suitable for high-density recording and satisfactory thermal fluctuation characteristics can be attained. When the Cr content exceeds the above range, the Ku of magnetic grains would be reduced to deteriorate the thermal fluctuation characteristics and deteriorate the crystallinity and orientation of magnetic grains with the result that the read/write characteristics would be deteriorated.

The perpendicular magnetic recording layer may contain at least one additive element selected from B, Ta, Mo, Cu, Nd, W, Nb, Sm, Tb, Ru and Re in addition to Co, Pt, Cr and the oxide. The introduction of any of these additive elements would promote micronization of magnetic grains or enhance the crystallinity and orientation thereof with the result that read/write characteristics and thermal fluctuation characteristics highly suitable to high-density recording can be attained. It is preferred for the total amount of these additive elements to be 8 at % or less. When the additive elements exceed 8 at %, a phase other than the hcp phase would be formed in magnetic grains, so that the crystallinity and orientation of magnetic grains would be disordered with the result that read/write characteristics and thermal fluctuation characteristics suitable for high-density recording cannot be attained.

Examples of other materials for the perpendicular magnetic recording layer include a CoPt alloy, a CoCr alloy, a CoPtCr alloy, CoPtO, CoPtCrO, CoPtSi and CoPtCrSi. A multilayer film comprising Co and an alloy containing as a main component at least one selected from the group consisting of Pt, Pd, Rh and Ru can be used as the perpendicular magnetic recording layer. Moreover, a multilayer film of CoCr/PtCr, CoB/PdB and CoO/RhO in which Cr, B or O is added to each of the layers of the above multilayer film can be used.

The thickness of the perpendicular magnetic recording layer is preferably in the range of 5 to 60 nm, more preferably 10 to 40 nm. The perpendicular magnetic recording layer with a thickness falling within this range is suitable for high recording density. When the thickness of the perpendicular magnetic recording layer is less than 5 nm, read outputs would tend to be extremely low with a result that noise components are made higher. On the other hand, when the thickness of the perpendicular magnetic recording layer exceeds 40 nm, read outputs would tend to be extremely high, resulting in waveform distortion. It is preferred for the coercitivity of the perpendicular magnetic recording layer to be 237,000 A/m (30000e) or higher. When the coercitivity is below 237,000 A/m (30000e), the thermal fluctuation resistance would tend to be poor. It is preferred for the perpendicular squareness of the perpendicular magnetic recording layer to be 0.8 or higher. When the perpendicular squareness is below 0.8, the thermal fluctuation resistance would tend to be poor.

<Lubricant>

Perfluoropolyether, fluoroalcohol, and fluorinated carboxylic acid can be used for the lubricant.

The second magnetic recording layer 5 deposited by the FCA method has hardness (thin-film hardness measured by a nanoindicator) of about 1.5 times that of the layer deposited by sputtering, so that an enhancement of corrosion resistance can be attained. Therefore, elution of cobalt from the first magnetic recording layer 4 disposed under the second magnetic recording layer 5 can be suppressed. Further, the second magnetic recording layer 5 deposited by the FCA method is excellent in surface smoothness, this being advantageous from the viewpoint of reducing the flying height of a magnetic head.

In the above embodiment, since the carbon-based protective layer 6 is also deposited by the FCA method, the carbon-based protective layer 6 also has high hardness, making it possible to attain enhancement of corrosion resistance, and is excellent in surface smoothness. In the present invention, however, the carbon-based protective layer 6 may be deposited by sputtering or plasma CVD.

In the art, a method comprising depositing the second magnetic recording layer 5 by sputtering and depositing thereon the carbon-based protective layer 6 thereon by the FCA method is known (see, for example, JP-A-2004-54991). However, since the incident energy is intense in depositing the carbon-based protective layer 6 by the FCA method, this method has posed the problem that a mixing layer is formed at the interface of the carbon-based protective layer 6 and the second magnetic recording layer 5 deposited by sputtering and having poor hardness with the result that the magnetic characteristics and protective characteristics would be deteriorated.

In contrast, when the second magnetic recording layer 5 is deposited by the FCA method so as to increase the hardness thereof as in the above embodiment, the formation of such a mixing layer in depositing the carbon-based protective layer 6 by the FCA method can be suppressed. Therefore, the magnetic characteristics and protective characteristics can be maintained.

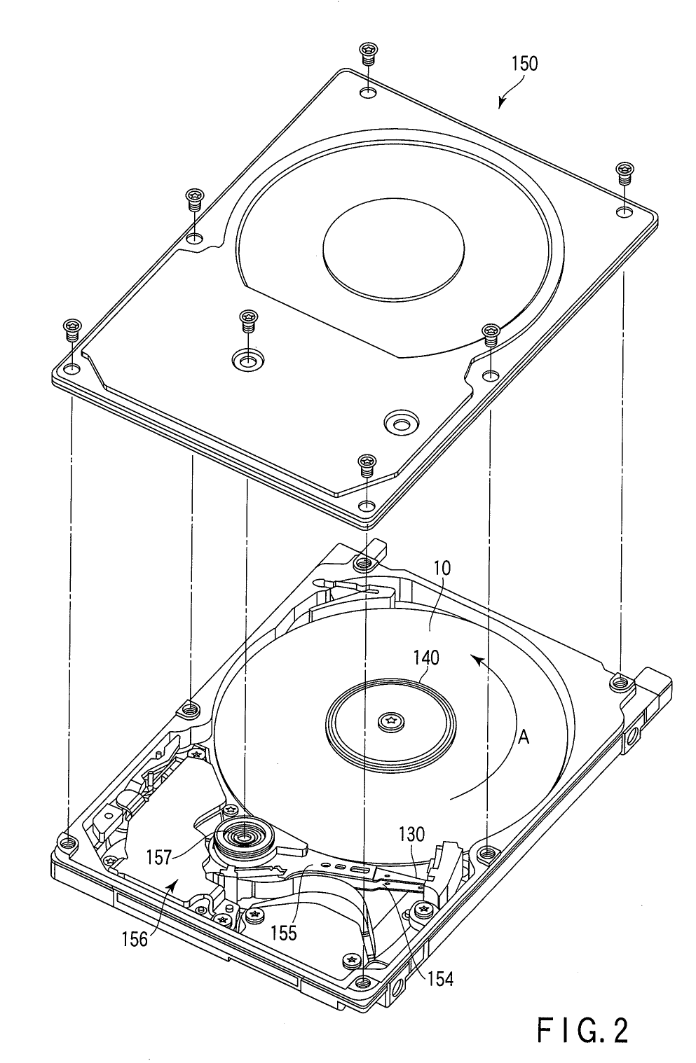

Now, the magnetic recording apparatus (HDD) will be described below. FIG. 2 is a perspective view of a magnetic recording apparatus in which the magnetic recording medium according to the present invention is installed.

As shown in FIG. 2, the magnetic recording apparatus 150 according to the embodiment is of a type using a rotary actuator. The magnetic recording medium 10 is attached to the spindle 140, and is rotated in the direction of arrow A by a motor (not shown) that responds to control signals from a drive controller (not shown). The magnetic recording apparatus 150 may comprise a plurality of magnetic recording media 10.

The head slider 130 configured to read from and write to the magnetic recording medium 10 is attached to the tip of the film-like suspension 154. The head slider 130 has a magnetic head mounted near the tip thereof. When the magnetic recording medium 10 rotates, the air bearing surface (ABS) of the head slider 130 is held at a predetermined height so as to fly over the surface of the magnetic recording medium 10 under a balance of pressing force of the suspension 154 and the pressure produce on the air bearing surface (ABS) of head slider 130.

The suspension 154 is connected to one end of an actuator arm 155. A voice coil motor 156, a kind of linear motor, is provided on the other end of the actuator arm 155. The voice coil motor 156 is formed of a magnetic circuit including a driving coil (not shown) wound around a bobbin and a permanent magnet and a counter yoke arranged opposite to each other so as to sandwich the coil therebetween. The actuator arm 155 is held by ball bearings (not shown) provided at two vertical positions of the pivot 157. The actuator arm 155 can be rotatably slid by the voice coil motor 156. As a result, the magnetic head can be accessed any position on the magnetic recording medium 10.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A method of manufacturing a magnetic recording medium comprising:
sequentially depositing at least two magnetic recording layers and a carbon-based protective layer on a nonmagnetic substrate, and
depositing an uppermost layer of the at least two magnetic recording layers by cathodic arc discharge.
